(19) United States
(12) Patent Application Publication
(10) Pub. No.: US 2003/0135712 A1
(43) Pub. Date: Jul. 17, 2003

(54) Microprocessor having an instruction format contianing timing information

(76) Inventor: Jean-Paul Theis, Hamburg (DE)

Correspondence Address: Ante Vista Gmbh, Harburger Schlossstrasse 6-12, Hamburg, D-21079, DE

(21) Appl. No.: 10/111,591

(22) PCT Filed: Jul. 13, 2001
(86) PCT No.: PCT/EP01/08169

(51) Int. Cl. G06F 9/30

(52) U.S. Cl. 712/214

(57) ABSTRACT

The present invention describes a microprocessor (CPU, DSP, micro-controller, ASIP etc. ) having an instruction format containing timing information. Said timing information is contained in one or more bit-fields of said instruction format and determines instruction scheduling and execution when a machine code running on said microprocessor. Said instruction format refers as well to ‘implicit’ instructions and to ‘implicit and potential’ instructions where the instruction is not explicitly specified by an ‘opcode’ bit-field in the instruction format.

### 1. FIELD OF THE INVENTION

The invention is dealing with instruction formats of microprocessors.

### 2. CONVENTIONS, DEFINITION OF TERMS, TERMINOLOGY

If not explicitly mentioned otherwise, the terms defined in this section are identical to those found in the literature. A good reference book on the subject is f. ex. ‘Computer Architecture: A Quantitative Approach, J. Hennessy and D. Patterson, Morgan Kaufmann Publishers, 1996’. In the context of the present invention, the term ‘microprocessor’ means also a central processing unit (CPU), a digital signal processor (DSP), any special-purpose (graphics) processor or any application specific instruction set processor (ASIP), whether embedded or stand-alone. One of the main characteristics of a microprocessor is the fact that it has an instruction set. In other words, the machine code of a program (e.g. specified in a programming language like C++) which is running or executed on said microprocessor, contains instructions belonging to said instruction set. Said machine code is usually obtained by compiling the source code of said program or by manual writing. Each instruction of a said instruction set has an instruction format. Furthermore, said microprocessor may have several different instruction formats such that instructions of a machine code may have different instruction formats.

As usual, the term ‘instruction format’ refers to a sequence of bit-fields of a certain length. Said bit-fields may be of different length. An instruction format usually contains a so called ‘opcode’ bit-field and one or more ‘operand’ bit-fields. FIG. 1 illustrates the discussed concepts. The ‘opcode’ bit-field encodes (defines) a specific instruction among all the instructions of an instruction set, e.g. the addition of two numbers or the loading of data from memory or a cache. The ‘operand’ bit-fields specify (encode) the operands of the instruction. In other words, an instruction is a data operation which is specified by (encoded in) the ‘opcode’ bit-field and where the data (or operands) required (or used) by said operation are specified by (encoded in) the ‘operand’ bit-fields. Usually, the operands are often given (specified) in form of either memory references or memory addresses or in form of register contents in which case the registers are identified by (encoded in) said ‘operand’ bit-fields. E.g. in case of a microprocessor with a register file containing 128 registers, an ‘operand’ bit-field of at least 7 bits is required to uniquely identify (encode) a specific register inside the register file. In addition to the ‘operand bit-fields, an instruction format often contains also a ‘destination’ bit-field which specifies where the data result of said instruction (or data operation) has to be stored. E.g. the data result of an arithmetic instruction like an addition of two numbers is equal to the sum of said numbers. The data result (or the outcome) of ‘compare’-instructions comparing two numbers x and y, e.g. instructions like ‘x equal-to y’, ‘y smaller-than y’, ‘x greater-than y’ etc . . . , is equal to a boolean value of either ‘0’ or ‘1’ depending on whether the comparison is true or false. In case of so-called ‘two-address’ machines, one of said ‘operand’ bit-fields plays at the same time the role of a ‘destination’ bit-field such that the operand specified by said ‘operand’ bit-field is at the same time ‘destination’ of said instruction. As for operands, destinations are often given in form of either memory references, memory addresses or in form of register contents. Furthermore, ‘compare’-instructions often write their data results (often called ‘flag-bits’) into dedicated destinations like status-registers or flag-registers, even if there is no ‘destination’ bit-field in the instruction format which specifies any flag-register or status-register.

In the context of the present invention, the length and the order of the bit-fields making up the format of an instruction is not relevant. In other words, it doesn't matter whether the ‘opcode’ bit-field is preceding the ‘operand’ bit-fields or vice versa nor does the order of the ‘operand’ bit-fields among each other matter. The encoding of the bit-fields is not relevant as well. Furthermore, instruction formats may be of fixed or of variable length and may contain a fixed number or a variable number of operands. In case of a variable instruction format length and a variable number of operands, additional bit-fields may be spent for these purposes. However, format length and number of operands may also be part of the ‘opcode’ bit-field. Also, an ‘operand’ bit-field is often given in form of an ‘address specifier’ bit-field and an ‘address’ bit-field. The ‘address specifier’ bit-field determines the addressing mode for the considered operand, e.g. indirect addressing, offset addressing etc . . . , whereas the ‘address’ bit-field determines the address of the considered operand within a memory space.

Within the scope of the present invention, it is assumed that a microprocessor has means (hardware circuitry) to measure time by using some method, otherwise machine code that is running on said microprocessor may produce wrong data or wrong results. Said terms ‘measure time’ or ‘time measurement’ have a very broad meaning and implicitly assume the definition of a time axis and of a time unit such that all points in time, time intervals, time delays or any arbitrary time events refer to said time axis. Said time axis can be defined by starting to measure the time that elapses from a certain point in time onwards, this point in time usually being the point in time when said microprocessor starts operation and begins to execute a said machine code. Said time unit, which is used to express the length of time intervals and time delays as well as the position on said time axis of points in time or any other time events, may be a physical time unit (e.g. nanosecond) or a logical time unit (e.g. the cycle of a clock used by a synchronously clocked microprocessor).

Synchronously clocked microprocessors use the cycles, the cycle times or the periods of one or more periodic clock signals to measure time. In the text that follows, a clock signal is referred to simply as a clock. However, the cycle of a said clock may change over time or during execution of a machine code on said microprocessor, e.g. the SpeedStep Technology used by Intel Corporation in the design of the Pentium IV microprocessor. Asynchronously clocked microprocessors use the travel times required by signals to go through some specific hardware circuitry as time units. In case of a synchronously clocked microprocessor, said time axis can be defined by starting to count and label the clock cycles of a said clock from a certain point in time onwards, this point in time usually being the point in time when said microprocessor starts operation and begins to execute machine code.

Therefore, if a microprocessor is able to measure time, then this means that said microprocessor is able find to out the chronological order of any two points in time or of any two time events on said time axis. In the case of a synchronously clocked microprocessor, this is done by letting said microprocessor operate with a clock in order to measure time with multiples (maybe integer or fractional) of the cycle of said clock, where one cycle of said clock can be seen as a logical time unit. E.g., if f. ex. a time delay (time interval) is equal to 34.4 ns and the cycle time of a said clock is equal to 12.3 ns, then said time delay would be equal to 34.4/12.3=2.79 logical time units or 2.79 cycle units. Furthermore, the clock which is used to measure time is often the clock with the shortest cycle time such that said cycle is the smallest time unit (logical or physical) used by a synchronously clocked microprocessor in order to perform instruction scheduling and execution, e.g. to schedule all internal operations and actions necessary to execute a given machine code in a correct way.

However the scope of the present invention is independent of whether a said microprocessor is synchronously clocked or whether it uses asynchronous clocking, asynchronous timing or any other operating method or timing method to run and execute machine code.

Whatever the clocking scheme or the operating method (synchronous or asynchronous) or the time measurement method used by a microprocessor, it is usual that instructions are pipelined. This means that:

1) said microprocessor has one or more instruction pipelines which contain each several (pipeline) stages and that instructions may take each different amounts of time (in case of a synchronously clocked microprocessor: several cycles of said clock) to go through the different stages of a said instruction pipeline before completing execution. The first pipeline stage is usually a ‘prefetch’ stage, followed by ‘decode’ and ‘dispatch’ stages, the last pipeline stage being often a ‘write back’ or an ‘execution’ stage. One often speaks of different phases through which an instruction has to go, e.g. ‘fetch’, ‘decode’, ‘dispatch’, ‘execute’, ‘write-back’ phases etc., each phase containing several pipeline stages. Therefore, the execution of an instruction may include the pipeline stages (and the amount of time) which are required to write or to store or to save operands or data results into some memory location, e.g. into a register, into a cache or into main memory. In the case of a synchronously clocked microprocessor, multiples (integer or fractional) of the cycle of said clock can be used as well to specify the depth and the number of the instruction pipeline stages of a microprocessor. The number of pipeline stages that a given instruction has to go through is often called the latency of said instruction. In case of a synchronously clocked microprocessor, said latency is often given in cycle units of a clock.

An instruction is said to be executed or to have commenced execution if said instruction has entered a certain pipeline stage, and where said pipeline stage is often the first stage of the execution phase. An instruction is said to have finished execution if it has left a certain pipeline stage, said pipeline stage being often the last stage of the execution phase. The point in time (on said time axis) at which a given instruction enters a pipeline stage is called the ‘entrance point’ of said instruction into said pipeline stage. The point in time at which a given instruction leaves a pipeline stage is called the ‘exit point’ of said instruction out of said pipeline stage.

From the operating principles of instruction pipelines in general, it is recalled that if an instruction enters a certain pipeline stage then said instruction usually triggers certain operations (also called microoperations) or events internal to the microprocessor which are required to operate and to execute machine code correctly and which are determined by the functionality of said pipeline stage and which are usually part of a so-called microcode of said instruction. Therefore, microcode and microoperations usually differ from pipeline stage to pipeline stage. Note that microcode has not to be confused with machine code.

2) an instruction may enter a stage of an instruction pipeline before another instruction has left another stage of the same instruction pipeline. E.g. if an instruction pipeline has 4 stages denoted by P1,P2,P3,P4, then an instruction A1 may enter stage P2 at some point in time t1 while another instruction labeled by B1 enters stage P4 at the same point in time t1. It is also possible that the instruction pipeline of a microprocessor is such that instruction A1 may enter a stage before another instruction B1 has left the same stage.

The term instruction pipeline is still valid and keeps the same meaning even if instructions are not pipelined. In this case, an instruction pipeline has one single stage. In case of a synchronously clocked microprocessor, an instruction usually takes one cycle of a said clock to go through one stage of an instruction pipeline. Typical depths of instruction pipelines of prior-art microprocessors range between 5 to 15 stages. E.g. the Pentium IV processor of Intel Corporation has an instruction pipeline containing 20 stages such that instructions may require up to 20 clock cycles to go through the entire pipeline, whereas the Alpha 21264 processor from Compaq has only 7 stages.

In the following, the terms ‘instruction scheduling’ and ‘instruction execution’ play an important role in the definition of the scope of the present invention. In order to show the generality of the scope of the present invention, we give first of all a broader definition of these terms:

in the context of a microprocessor executing some machine code, the terms ‘instruction scheduling’ and ‘instruction execution’ refer to the determination of the points in time of a time axis (as defined above) at which some operations or some time events are occurring (or are taking place) within a said microprocessor in order to allow for a correct execution of machine code on said microprocessor

A definition of the previous terms which is closer to a physical use and implementation of an instruction format as based on the present invention and which is included in and is a special case of the previous definition, is as follows:

the terms ‘instruction scheduling’ and ‘instruction execution’ refer to the determination of the points in time on said time axis at which a given instruction of a machine code running on a said microprocessor enters or leaves one or more stages of an instruction pipeline of a said microprocessor in order to complete (finish) execution. In case of a synchronously clocked microprocessor, said points in time can be integer or fractional multiples of a cycle, cycle time or period of a clock.

Both definitions will be used in section 5 in order to describe in more detail the scope of the present invention.

Note that the terms ‘instruction scheduling’ and ‘instruction execution’ have not to be confused with the instruction scheduling done by compiler techniques like software pipelining, list or trace scheduling etc...

### 3. PRIOR ART

In the context of the present invention, instruction formats containing one or more so-called ‘predication’ bit-fields are of particular interest because ‘predication’ bit-fields can be used to delay the execution of an instruction. Instructions having an instruction format containing ‘predication’ bit-fields are called ‘predicated’ instructions. They have recently been used in the design of instruction sets of prior-art microprocessors, e.g. the IA-64 instruction set from Intel Corporation. Said ‘predication’ bit-fields often specify registers (so-called predication registers) or memory addresses but they may also specify values. In other words, a bit-field of 5 bits like f. ex. ‘10010’ may specify either the decimal value 18 in an unsigned binary number representation, or it may specify the register identified (encoded) by the bit-field ‘10010’ within a register file of 2⁵=32 registers or it may specify a memory address identified (encoded) by ‘10010’ within an address space of 2⁵=32 address locations.

The information contained in the ‘predication’ bit-fields, e.g. the values as well as the contents (values) stored within the predication registers or memory addresses specified by said ‘predication’ bit-fields, are used by a microprocessor:

1) to determine whether a predicated instruction shall be executed or not

2) to determine whether an already commenced execution of a predicated instruction is valid or not or shall be canceled or not

3) to determine whether the data result of a predicated instruction which has finished execution is valid or not

4) to delay the execution of a predicated instruction until (or to execute a predicated instruction as soon as) the values or the contents of the registers or the memory addresses specified by said ‘predication’ bit-fields have a certain value

In order to understand the difference with the present invention, it is important to see that ‘predication’ bit-fields do not specify

1) neither a value representing a time interval (time delay) or point in time expressed in some time unit (e.g. expressed in nanoseconds or in microseconds or in cycle units of some clock)

2) nor a content of a register or of a memory address which is used to calculate such a time interval or time delay

and where said time interval, time delay or point in time would be used to determine instruction scheduling and execution, e.g. the entrance points or exit points of a predicated instruction into or out of one or more instruction pipeline stages.

### 4. BRIEF DESCRIPTION OF THE DRAWINGS

FIG. 1 shows an example of a prior-art instruction format containing bit-fields for ‘opcode’ and ‘operands’.

FIG. 2 shows an example of an instruction format as based on the present invention and containing several bit-fields containing timing information.

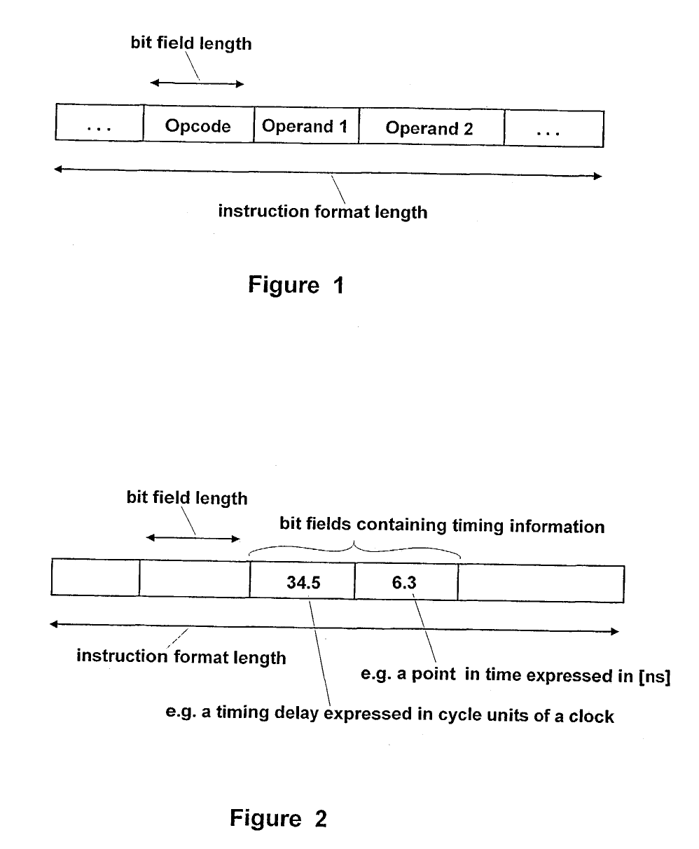

### 5. DETAILED DESCRIPTION OF THE DRAWINGS

The main aspects of the present invention are described by referring to FIG. 2 mentioned in section 4. In the context of the present invention and in the text that follows, the term ‘instruction format’ has a slightly broader meaning than the one of the prior art and includes instruction formats where no instruction (or data operation) is specified neither in said ‘opcode’ bit-field nor in any other bit-field of the instruction format. In other words, either one or more ‘implicit’ instructions or one or more ‘implicit and potential’ instructions are associated to the data (or operands) specified by the ‘operand’ bit-fields or by any other bit-fields contained in the instruction format. However, in this case we still speak of an instruction having such an instruction format although there is no instruction explicitly specified by an ‘opcode’ bit-field or by any other bit-field in said instruction format.

An ‘implicit’ instruction is defined to be an instruction which is known by the microprocessor prior to execution of said instruction and where said instruction has not to be specified by an ‘opcode’ bit-field or any other bit-field in an instruction format of said instruction. However, as mentioned before, an ‘implicit’ instruction may well have one or more operands and one or more destinations specified in corresponding bit-fields of said instruction format. It is also possible that an ‘implicit’ instruction may have no operands and no destination specified in any bit-field of the instruction format. In this case, the ‘implicit’ instruction may be f. ex. a special-purpose instruction which initializes some hardware circuitry of the microprocessor or has some other well defined meaning or purpose.

Always in the context of a machine code running on a said microprocessor, an ‘implicit and potential’ instruction is an ‘implicit’ instruction where the data results or the outcome of instructions which have not yet finished execution decide whether:

5) said ‘implicit and potential’ instruction shall be executed or not

6) an already commenced execution of said ‘implicit and potential’ instruction is valid or not or shall be canceled or not

7) the data result of a said ‘implicit and potential’ instruction which has finished execution is valid or not

In other words, the execution of an ‘implicit and potential’ instruction is delayed and is decided upon until other instructions have finished execution, although said instruction may have already entered an instruction pipeline stage like f. ex. a ‘fetch’ or ‘decode’-stage. It is important to see that ‘predicated’ instructions are special cases of ‘implicit and potential’ instructions.

Two small examples shall clarify the meaning of an ‘implicit’ instruction’ and an ‘implicit and potential’ instruction.

E.g. assume a microprocessor having an instruction format (among other instruction formats) as based on the present invention and running a machine code containing instructions out of an instruction set of said microprocessor. Furthermore, assume that said instruction format contains two ‘operand’ bit-fields and no other bit-fields. Furthermore, assume that said microprocessor has to execute an instruction having said instruction format and that said two bit-fields specify two operands designated f. ex. by ‘op1’ and ‘op2’. In this case, an example of an ‘implicit instruction’ associated to these two operands can be any kind of instruction (or data operation) like the addition or the multiplication of these two operands or the loading of these two operands from a memory or a register file etc. . . . , and where said implicit instruction can be specified f. ex. by convention for the whole time of execution of said machine code or can be specified by another instruction which was executed prior to said instruction. An example of an ‘implicit and potential instruction’ associated to these two operands is f. ex. a load- or a move-instruction which is loading the two operands from some memory 1) only after certain instructions not yet executed have been executed and 2) only if the outcome of the data results of said instructions satisfy certain conditions.

In the context of the present discussion, instruction formats having bit-fields containing timing information appear naturally and go beyond the capability of ‘predicated’ instructions because (in contrast to ‘predicated’ instructions) said timing information specifies time delays and/or points in time (on a time axis as defined in section 2) which are used by a said microprocessor to determine instruction scheduling and execution.

Since a time interval is in essence the same thing as a time delay, namely an amount of time which elapses between two points in time, in the text that follows the term ‘time delay’ will also mean any kind of time interval.

Therefore, it is assumed in the following that if a said microprocessor uses a point in time to determine instruction scheduling and instruction execution during execution of a machine code then said microprocessor has also means to find out when said point time is reached during execution of said machine code.

This type of information was not required within prior-art instruction formats because the architecture concepts of prior-art microprocessors do not use this type of timing information. This is due to the fact that prior-art instruction scheduling is done either (1) in case of super-scalar microprocessors by dynamic scheduling mechanisms based on data dependence analysis of instructions contained in a more or less large instruction window of the machine code of a given program or (2) in case of VLIW processors by static scheduling techniques, in particular by software pipelining and trace scheduling, such that instructions are scheduled and executed in the same order in which they are arranged in the machine code, where said machine code is generated by applying said static scheduling techniques or (3) in case of EPIC processors, e.g. the IA-64 from Intel Corporation, by a mixture of the approaches (1) and (2).

FIG. 2 shows an example of an instruction format as based on the present invention containing several bit-fields containing timing information. The main aspect of the present invention consists in introducing timing information into instruction formats and where said timing information specifies time delays and/or points in time (on a time axis as defined in section 2) which are used to determine instruction scheduling and instruction execution.

Therefore, by using the first definition of the terms ‘instruction scheduling’ and ‘instruction execution’ as given in section 2, the most general definition of timing information contained in an instruction format of a microprocessor as based on the present invention is as follows:

a. said timing information is defined to be one or more time delays and/or points in time whose values (or lengths) are expressed in some time unit and which are used by said microprocessor to determine instruction scheduling and instruction execution. Therefore, in the absence of said timing information said instruction scheduling and instruction execution maybe different from the case where timing information is present

By using the other definition given in section 2 and which is derived from the previous more general definition, explicit timing or delay information contained in an instruction format as based on the present invention represents either:

b. one or more time delays and/or points in time expressed in some time unit, where said time delays and/or said points in time are used by said microprocessor to determine the points in time (on said time axis) at which an instruction having a said instruction format and being part of a machine code running on said microprocessor enters or leaves some stages of an instruction pipeline, and where the values of said time delays and/or said points in time do not depend on the outcome or on the data results of instructions which have not yet finished execution at a point in time when said microprocessor uses said information to calculate said time delays and/or said points in time

c. one or more time delays and/or points in time expressed in some time unit, where said time delays and/or said points in time are used by said microprocessor to calculate other time delays and/or other points in time, where said other time delays and/or said points in time are used by said microprocessor to determine the points in time (on said time axis) at which an instruction having a said instruction format and being part of a machine code running on said microprocessor enters or leaves some stages of an instruction pipeline, and where the values of said time delays and/or said points in time do not depend on the outcome or on the data results of instructions which have not yet finished execution at a point in time when said microprocessor uses said information to calculate said time delays and/or said points in time

It is important to explain the generic formulation of points a., b. and c. in further detail, in particular in order to show the difference with ‘predicated’ instructions.

First, one should note that points a., b. and c. do not further specify how said microprocessor uses said time delays and/or said points in time to determine instruction scheduling and execution and in particular said points in time. In other words, said instruction scheduling and execution or said points in time can be determined f. ex. by setting them equal to (the values of) said time delays and/or said points in time (see examples below) or by using some other expression or method.

In practice, said time delays and/or said points in time usually determine the earliest possible points in time at which an instruction enters or leaves certain pipeline stages. In other words, the amount of time that elapses between the point in time at which said microprocessor calculates a time delay and/or a point in time in order to determine a said earliest possible point in time and the point in time at which said instruction effectively enters or leaves some stages of an instruction pipeline is at least equal to (the value of) said time delay and/or said point in time. In other words, it usually happens that said instruction will actually enter or leave said pipeline stages at a later point in time than specified by said earliest possible point in time as calculated by the microprocessor, this difference being due to resource constraints (e.g. ALU resource conflicts, bus access conflicts etc . . . ) caused by the dynamic instruction scheduling being done by said microprocessor during the execution of a machine code.

The difference between points a., b. and c. and the definition of ‘predicated’ instructions is clear ‘predicated’ instructions (more precisely the predication bit-fields) do not specify a time delay nor a point in time expressed in some time unit.

Furthermore, it is important to see that point c. includes the possibility that a microprocessor may also use the information stored in other bit-fields to calculate said other time delays and/or said other points in time, f. ex. by using the contents (values) stored inside operand registers, destination registers, predication registers or flag-bit registers or in form of information stored in any other bit-fields of the instruction format of said instruction. E.g. (the value of) a time delay or a point in time denoted by ‘t’ can be calculated by using the value of some predication register, operand register or destination register specified in the instruction format of a given instruction. F. ex. if the value of said predication register is denoted by ‘pred’, the value of said operand register denoted by ‘op’, the value of said destination register denoted by ‘dst’ and the value of another point in time equal to 10.1, then said time delay or said point in time t can be calculated by using some arithmetic expression like t=4.76+(2·pred−3.51·op)/(5·dst)+10.1. Note that in this expression, not all values have necessarily to be expressed in the same time unit.

Furthermore, time delays and/or points in time contained in some bit-fields of a said instruction format of a given instruction may well refer to another instruction. In other words a time delay and/or a point in time contained in the instruction format of an instruction denoted by ‘A’ may determine the instruction scheduling and execution of that same instruction ‘A’ or of some other instruction.

Furthermore, point c. also includes the possibility that a microprocessor may use information stored in one or more arbitrary bit-fields of instruction formats of other instructions. E.g., said microprocessor may well use information stored in some bit-fields of the instruction format of an instruction denoted by A and of another instruction denoted by B in order to calculate a time delay and/or a point in time which determines the scheduling and execution of another instruction denoted by C.

It is recalled that, according to the above definition of an instruction format, the concept of ‘implicit’ and ‘implicit and potential’ instructions as well as ‘predicated’ instructions is compatible with the concept of timing information contained in an instruction format as based on the present invention and as defined in points a., b. and c. above. In other words, a time delay and/or a point in time is used to determine the scheduling and execution of an ‘implicit’ or an ‘implicit and potential’ or a ‘predicated’ instruction in the same way as it is used for other instructions. E.g. if (the value of) a point in time and/or a time delay denoted by ‘t’ has to be used to determine the scheduling and execution of an ‘implicit and potential’ instruction, this means that a said microprocessor:

d. delays the decision whether said ‘implicit and potential’ instruction shall be executed or not (or shall enter or leave a certain stage of an instruction pipeline or not) by an amount of time which is determined by (the value of) said time delay t and/or until said point in time t is reached

e. delays the decision whether an already commenced execution of said ‘implicit and potential’ instruction is valid or not or shall be canceled or not by an amount of time which is determined by (the value of) said time delay t and/or until said point in time t is reached

f. delays the decision whether the data result of a said ‘implicit and potential’ instruction which has finished execution is valid or not by an amount of time which is determined by (the value of) said time delay t and/or until said point in time t is reached

As before, points d., e. and f. do not further specify how said microprocessor uses said time delays and/or said points in time to determine said amounts of time by which to delay said decisions. In other words, said amounts of time can be determined f. ex. by setting them equal to (the values of) said time delays and/or said points in time (see examples below) or by using some other expression or method.

We now address in further detail two questions related to instruction formats containing timing information as based on the present invention:

(1) given explicit timing information, how does a microprocessor use in practice that timing information in order to determine the points in time (on a time axis as mentioned in section 2.) at which a given instruction enters or leaves a certain stage of an instruction pipeline?

(2) how is said timing information encoded?

To question (1): Here we only consider the case for a synchronously clocked microprocessor in more detail. It is straightforward to extend the following discussion to asynchronous microprocessors by replacing the time unit (e.g. the cycle time of a clock) of a synchronously clocked microprocessor by that of an asynchronous microprocessor.

As mentioned before, it is natural to take as time unit the cycle or the cycle time of a clock of said microprocessor and to define a time axis as explained in section 2.

We first discuss the case where a point in time (on said time axis) at which a given instruction enters or leaves a certain pipeline stage of a certain instruction pipeline, e.g. an ‘execution’ stage, is contained in said timing information in form of a time delay. The following considerations remain valid if time delays are replaced by points in time or by any mixture thereof.

In practice, as soon as a said microprocessor fetches a said instruction from some memory address and decodes said timing information contained in one or more bit-fields of the instruction format of said instruction, said microprocessor calculates and determines said point in time:

by adding said time delay to a so-called time reference either of said instruction or of another instruction, or

by adding said time delay to the point in time (on said time axis) at which said instruction or another instruction entered or left a previous pipeline stage, or

Said time reference (also called in the following ‘time zero’) can be defined in many ways and the scope of the present invention is independent thereof. However the following definition is of practical interest:

the time reference is the point in time at which an instruction would enter or leave a certain pipeline stage in the absence of any timing (delay) information

The following example shall illustrate the concepts. Consider an instruction pipeline of 5 stages consisting of ‘fetch’, ‘decode’, ‘execute1’, ‘execute2’ and ‘write’ stages and assume that the bit-field of the instruction format containing explicit timing information for a given instruction contains the integers 2, 3 and 5. One possible meaning of these integer delays could be that said instruction would enter:

(a) the ‘execute1’ stage with a delay of 2 cycle units of a clock with respect to ‘time zero’ or alternatively 2 cycle units after it has entered the ‘decode’ stage

(b) the ‘execute2’ stage with a delay of 3 cycles after having entered the ‘execute1’ stage

(c) the ‘write’ stage with a delay of 5 cycles after having entered the ‘execute2’ stage.

As mentioned before, in practice said timing information will often be given in form of integers or fractional numbers representing one or more delays (in cycle units of a clock) according to which the entrance points or exit points of an instruction into or out of the different pipeline stages have to be delayed with respect to ‘point zero’ or with respect to the points in time at which said instruction or another instruction entered or left a certain pipeline stage, where said certain pipeline stage can be given implicitly (in the same way as for ‘implicit’ instructions’) or can be determined by the outcome or the data results of any other instructions of a machine code running on said microprocessor. It is of course assumed that said microprocessor contains some means or hardware circuitry to physically delay the entrance points or exit points of an instruction into or out of each pipeline stage individually. However, it is not relevant for the scope of the present invention how this mechanism is implemented in detail, whether the time delays are realized by stalls of the instruction pipeline or by some other method.

In the example above ‘incremental timing’ encoding was used, in other words the entrance point or exit point of an instruction into or out of a certain pipeline stage is determined by adding the delay to the entrance point or exit point into or out of a previous pipeline stage.

We now address question (2). Although there exist many possible encoding schemes, two practical encoding schemes shall be considered here: (a) ‘absolute timing’ (b) ‘incremental timing’ . ‘Incremental timing’ encoding has been used in the previous example. If ‘absolute timing’ encoding would be used instead, then said bit-fields containing said timing information would contain the integers 2, 5 (=2+3) and 10 (=2+3+5) respectively and all timing information would be with respect to the time reference (‘time zero’) of said instruction, in other words the ‘execute1’ stage would be entered or left 5 clock cycles after ‘time zero’ and the ‘execution2’ stage 10 clock cycles after ‘time zero’. As one can see, ‘incremental timing’ will normally require less bits to encode than ‘absolute timing’.

The concept of ‘incremental timing’ and ‘absolute timing’ can also be applied unchanged to two or more instructions which have to be scheduled and executed consecutively. Consider f. ex. a microprocessor containing an instruction pipeline with 3 stages. Consider an instruction i₁ containing timing information given in form of integer delays 2, 3 and 5. Consider another instruction i₂, which has to be scheduled and executed consecutively to instruction i₁ and which contains timing information given in form of integer delays 1, 2 and 3. Then, if ‘incremental timing’ was used to encode the mentioned delays, it would mean that if instruction i₁ enters or leaves said 3 pipeline stages at clock cycles labeled t+2, t+5, t+10 respectively (t being the time reference for said instruction), then instruction i₂ enters or leaves said 3 pipeline stages at clock cycles labeled (t+2,t+5,t+10)+(1,2,3)=t+2+1, t+5+2, t+10+3 respectively. Note that any said time delay may refer to an entrance point or to an exit point of an instruction or to both of them.

The definition of timing information contained in instruction formats as based on the present invention is such that even if there is only one single time delay or point in time specified in some bit-field of said instruction format, said delay may determine the entrance points or exit points into or out of one or more pipeline stages of a given instruction. E.g. assume that, in the absence of any timing information in the instruction format, an instruction would enter or leave certain pipeline stages at clock cycles labeled t, t+1, t+2 . . . respectively, where t is the time reference for said instruction. Then if the instruction format of said instruction would contain timing information in the form of a single time delay given by some integer value c, this would mean that the pipeline stages would now be entered or left at clock cycles labeled t+c, t+c+1, t+c+2 . . . respectively. In the case that the timing information contained in the instruction format of a given instruction contains (specifies) only one single time delay, one says that said time delay is associated to said instruction.

One major advantage of introducing timing information into instruction formats is to avoid hardware resource conflicts. E.g. consider the case of two instructions which are issued in parallel (in other words which enter the first execution stage at the same point in time), which have the same latencies and which must share the same ALU (Arithmetic Logic Unit) circuitry. Then, by delaying the entrance points into each pipeline stage appropriately, it is possible to avoid that the two instructions access the ALU at the same point in time.

As mentioned before, in all the discussions made before it is of course assumed that the microprocessor for which such an instruction format with explicit timing information is designed, contains means and hardware circuitry to delay the entrance points and exit points of the instructions into or out of the instruction pipeline stages according to the timing information contained in the instruction format of said instructions.

It is important to note that the scope of the present invention also covers the case in which all of or part of said timing information contained in instruction formats of one or more instructions of a machine code is stored as a separate part of said machine code or is stored in memory locations different from those where the rest of said machine code is stored. F. ex. this would be the case if the bit-fields containing timing information would be stored in different memory locations from those where the bit-fields containing ‘operand’, ‘opcode’ or ‘destination’ information of a given instruction are stored. Finally, since timing information contained in an instruction format as based on the present invention is part of a machine code running on a said microprocessor, it is recalled that said timing information is either calculated and generated by an appropriate compiler during machine code generation or is determined ‘by hand’ in case of hand-written machine code.

### 6. SUMMARY OF THE INVENTION

The present invention concerns a microprocessor having an instruction format containing explicit timing information according to claim 1.

What is claimed is:

1. A microprocessor having an instruction format containing timing information, where said instruction format refers to one or more instructions being part of an instruction set of said microprocessor,
where said instructions are part of a machine code running on said microprocessor,
where said timing information is specified in one or more bit-fields of said instruction format,
where said timing information represents either:
a. one or more time delays and/or one or more points in time expressed in some time unit, where said time delays and/or said points in time are used by said microprocessor to determine instruction scheduling and instruction execution
b. one or more time delays and/or one or more points in time expressed in some time unit, where said time delays and/or said points in time are used by said microprocessor to calculate other time delays and/or other points in time, where said other time delays and/or said other points in time are used by said microprocessor to determine instruction scheduling and instruction execution

2. A microprocessor having an instruction format as claimed in claim 1, where at least one of said time delays and/or said points in time is not equal to zero

3. A microprocessor having an instruction format as claimed in claim 1, where the values of said time delays and/or said points in time do not depend on the outcome and/or on the data results of instructions which have not yet finished execution at a point in time when said microprocessor uses said information to calculate said time delays and/or said points in time

4. A microprocessor having an instruction format as claimed in claim 1, where the values of said time delays and/or said points in time do not depend on the outcome and/or on the data results of instructions which have not yet finished execution at a point in time when said microprocessor uses said information to calculate said time delays and/or said points in time, where at least one of said time delays and/or said points in time is not equal to zero

5. A microprocessor having an instruction format as claimed in claim 1,
where said microprocessor contains one or more instruction pipelines containing each one or more pipeline stages,
where said timing information represents either:
c. one or more time delays and/or one or more points in time expressed in some time unit, where said time delays and/or said points in time are used by said microprocessor to determine the points in time at which an instruction having a said instruction format and being part of a machine code running on said microprocessor enters and/or leaves one or more stages of an instruction pipeline,
d. one or more time delays and/or one or more points in time expressed in some time unit, where said time delays and/or said points in time are used by said microprocessor to calculate other time delays and/or other points in time, where said other time delays and/or said other points in time are used by said microprocessor to determine the points in time at which an instruction having a said instruction format and being part of a machine code running on said microprocessor enters and/or leaves one or more stages of an instruction pipeline
where said microprocessor has means to delay said entrance points and exit points of said instructions into and out of one or more pipeline stages of an instruction pipeline according to said timing information,

6. A microprocessor having an instruction format as claimed in claim 5, where at least one of said time delays and/or one of said points in time is not equal to zero

7. A microprocessor having an instruction format as claimed in claim 5, where the values of said time delays and/or one of said points in time do not depend on the outcome or on the data results of instructions which have not yet finished execution at a point in time when said microprocessor uses said information to calculate said time delays and/or said points in time

8. A microprocessor having an instruction format as claimed in claim 5, where at least one of said time delays and/or one of said points in time is not equal to zero, where the values of said time delays and/or said points in time do not depend on the outcome and/or on the data results of instructions which have not yet finished execution at a point in time when said microprocessor uses said information to calculate said time delays and/or said points in time

9. A microprocessor having an instruction format as claimed in claim 5, where said time delays and/or said points in time are given in form of integer numbers

10. A microprocessor having an instruction format as claimed in claim 6, where said time delays and/or said points in time are given in form of integer numbers

11. A microprocessor having an instruction format as claimed in claim 7, where said time delays and/or said points in time are given in form of integer numbers

12. A microprocessor having an instruction format as claimed in claim 8, where said time delays and/or said points in time are given in form of integer numbers

13. A microprocessor having an instruction format as claimed in claim 5, where said time delays and/or said points in time determine the earliest possible points in time at which said instruction enters and/or leaves one or more pipeline stages of an instruction pipeline

14. A microprocessor having an instruction format as claimed in claim 6, where said time delays and/or said points in time determine the earliest possible points in time at which said instruction enters and/or leaves one or more pipeline stages of an instruction pipeline

15. A microprocessor having an instruction format as claimed in claim 7, where said time delays and/or said points in time determine the earliest possible points in time at which said instruction enters and/or leaves one or more pipeline stages of an instruction pipeline

16. A microprocessor having an instruction format as claimed in claim 8, where said time delays and/or said points in time determine the earliest possible points in time at which said instruction enters and/or leaves one or more pipeline stages of an instruction pipeline

17. A microprocessor having an instruction format as claimed in claim 13, where said time delays and/or said points in time are given in form of integer numbers

18. A microprocessor having an instruction format as claimed in claim 14, where said time delays and/or said points in time are given in form of integer numbers

19. A microprocessor having an instruction format as claimed in claim 15, where said time delays and/or said points in time are given in form of integer numbers

20. A microprocessor having an instruction format as claimed in claim 16, where said time delays and/or said points in time are given in form of integer numbers

21. A microprocessor having an instruction format as claimed in claim 5,
where said instruction format refers to all instructions of said instruction format,
where said machine code of said microprocessor contains exclusively instructions being part of said instruction set,
where said microprocessor operates with a clock such that all time indications referring to instruction scheduling and execution as well as the depth of an instruction pipeline of said microprocessor are given in cycle units of said clock,
where a time axis is defined by starting to count and label the cycles of said clock upwards from a certain point in time onwards or when microprocessor starts operation and begins to execute the machine code of a given program,
where instructions, being part of said machine code which is executed on said microprocessor, are pipelined such that instructions take one or more cycles to go through one or more stages of an instruction pipeline before completing execution,
where said timing information contained in the instruction format of an instruction contains one or more positive integer values representing time delays and/or points in time expressed in some unit and according to which one or more entrance points or exit points of said instruction into or out of one or more pipeline stages of an instruction pipeline have to be delayed either with respect to the point in time at which said instruction or another instruction entered and/or left another pipeline stage or with respect to ‘time zero’ of said instruction or of another instruction, where the entrance point of said instruction into the first pipeline stage is delayed with respect to ‘time zero’, where ‘time zero’ is the point in time at which said instruction or another instruction would enter and/or leave the first pipeline stage in the absence of any timing information
